(19) United States
(12) Patent Application Publication
(10) Pub. No.: US 2013/0162438 A1
(43) Pub. Date: Jun. 27, 2013

(54) SERVER SYSTEM FOR MONITORING STATUS OF FANS

(71) Applicants: KANG WU, Shenzhen City (CN); WEI-DONG CONG, Shenzhen City (CN)

(72) Inventors: KANG WU, Shenzhen City (CN); WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/620,328

(22) Filed: Sep. 14, 2012

(30) Foreign Application Priority Data
Dec. 27, 2011 (CN) 201110444178.1

(51) Int. Cl. G08B 21/18

(52) U.S. Cl. 340/670

(57) ABSTRACT

An exemplary server system includes an enclosure, a number of server groups, a number of fan rows, and a fan indicator system. The fan indicator system includes a number of fan control boards (FCBs), a baseboard management controller (BMC), and a terminal device. One FCB is connected to one of the fan rows to read rotational speeds of the fans of the corresponding fan row, and encodes the read rotational speeds to indicate positional information of the corresponding fan row and positional information of each fan on the corresponding fan row. The BMC receives and processes the encoded rotational speeds to determine whether the fans work normally. When at least one fan is determined to work abnormally by the BMC, the BMC outputs the encoded rotational speeds of the abnormal fans. The terminal device receives and displays the encoded rotational speeds of the abnormal fans.

### BACKGROUND

1. Technical Field

The disclosure generally relates to a server system for monitoring status of fans in rack servers.

2. Description of the Related Art

In rack servers, a plurality of fans are usually mounted in rows on a back of an enclosure of the rack servers to dissipate heat from the servers in the rack servers. However, because the fans are located at the back of the enclosure, it is inconvenient for users to monitor status of the fans through a baseboard management controller mounted inside the rack servers.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a block diagram of a server system, according to an exemplary embodiment, wherein the server system includes a fan indicator system.

FIG. 2 is a block diagram of the fan indicator system of FIG. 1, and showing the fan indicator system connected to fans shown in FIG. 1.

FIG. 3 is a schematic view of an enclosure and a terminal device of the server system shown in FIG. 1.

### DETAILED DESCRIPTION

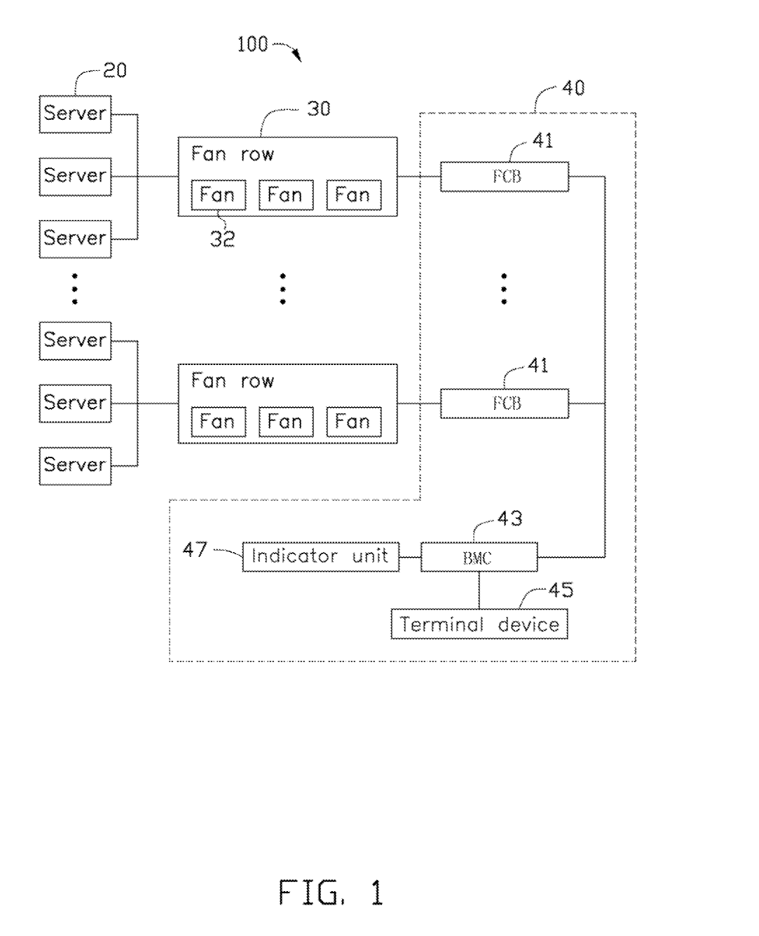

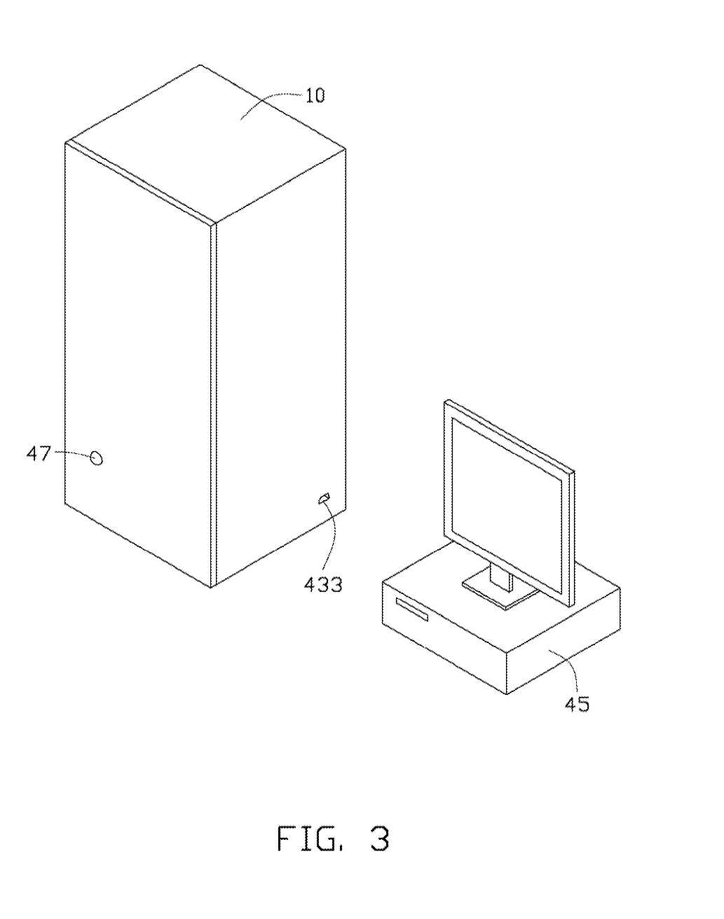

Referring to the FIGS. 1 and 3, an embodiment of a server system 100 is shown. The server system 100 includes an enclosure 10, a plurality of server groups 20 received in the enclosure 10, a plurality of fan rows 30, and a fan indicator system 40. One fan row 30 serves one server group 20 to dissipate heat from the server group 20. Each fan row 30 includes a plurality of fans 32.

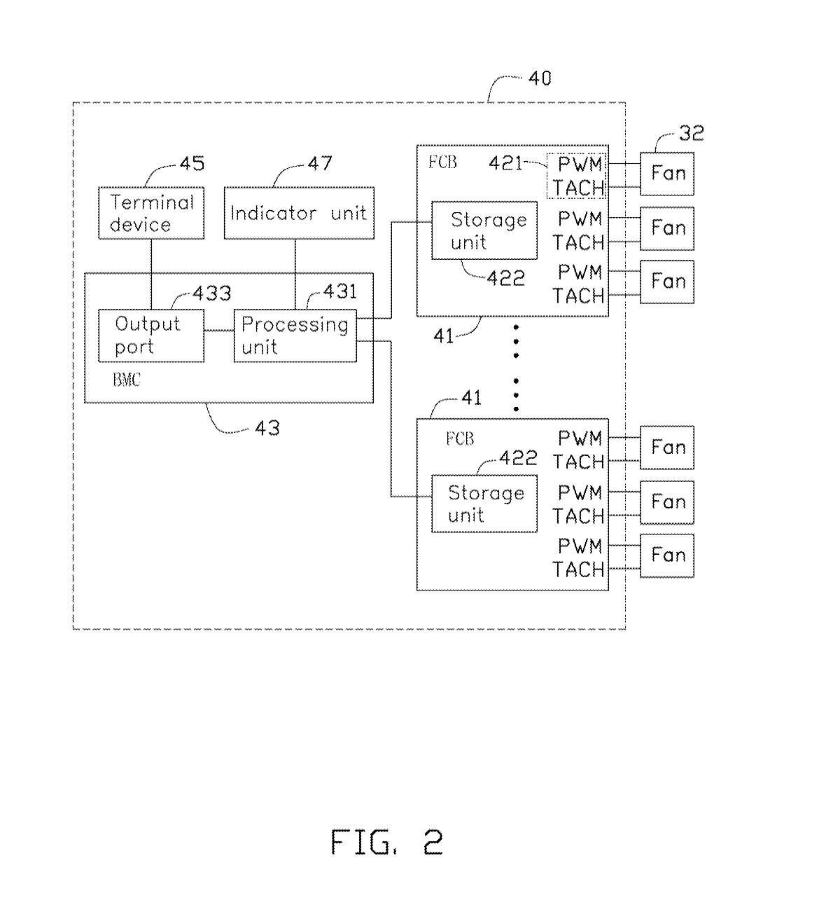

Referring to FIG. 2, the fan indicator system 40 includes a plurality of fan control boards (FCBs) 41, a baseboard management controller (BMC) 43, and a terminal device 45. One FCB 41 corresponds to one fan row 30. Each FCB 41 is electronically connected to each fan 32 of one fan row 30 to read a rotational speed of each fan 32 in the fan row 30, and adjusts the rotational speed of each fan 32 in the fan row 30 according to the read rotational speed. Each FCB 41 also stores positional information of the fan row 30 in the server system 100 and positional information of each fan 32 in the fan row 30. In detail, each FCB 41 includes a plurality of groups of control pins 421 and a storage unit 422. One group of control pins 421 corresponds to one fan 32. Each group of control pins 421 includes a rotational speed detecting pin TACH and a rotational speed control pin PWM. The rotational speed detecting pin TACH and the rotational speed control pin PWM are both connected to one fan 32 in the fan row 30. The FCB 41 monitors a rotational speed of the fan 32 through the rotational speed detecting pin TACH, and encodes the read rotational speed to denote positional information of the fan 32 on the corresponding fan row 30. The FCB 41 also outputs a pulse width modulation (PWM) signal through the rotational speed control pin PWM to control a rotational speed of the fan 32 according to the read rotational speed from the rotational speed detecting pin TACH. For example, when the FCB 41 outputs a PWM signal with an about 50% duty ratio through the rotational speed control pin PWM, the fan 32 will rotate to work in that duty ratio to decrease the rotational speed of the fan 32. When the FCB 41 outputs a PWM signal with an about 100% duty ratio through the rotational speed control pin PWM, the fan 32 will rotate to work in that duty ratio to increase the rotational speed of the fan 32. The storage unit 422 is connected to the BMC 43 through SMbus lines. The storage unit 422 stores positional information of the plurality of fan rows 30 and positional information of each fan 32 in the fan row 30, and outputs the coded rotational speed of each fan 32 to the

BMC 43.

The BMC 43 is electronically connected to the terminal device 45. The BMC 43 includes a processing unit 431 and an output port 433. The processing unit 431 can be an ARM9 processor. The processing unit 431 is connected to the storage unit 422 via SMbus lines. The processing unit 431 receives and processes the encoded rotational speeds of the fans 32 output by the FCB 41 to determine whether the fans 32 work normally. When at least one fan 32 is determined to work abnormally by the processing unit 431, the processing unit 431 will output the encoded rotational speeds of the fans 32 which are working abnormally through the output port 433. In one embodiment, the output 433 can be a RJ45 port, and can be located on a surface of the enclosure 10.

The terminal device 45 can be a computer. The terminal device 45 is electronically connected to the output port 433 through connection lines, such as network lines, for example, thereby connects to the BMC 43. The terminal device 45 receives and displays the encoded rotational speeds of the abnormal fans 32 on the fan row 30 through the output port 433 to convenient for maintaining or replacing the abnormal fans 32.

In other embodiment, the server system 100 further includes an indicator unit 47. The indicator unit 47 may be a light-emitting diode or other similar devices. The indicator unit 47 is positioned on a surface of the enclosure 10 and electronically connected to the processing unit 431. When at least one fan 32 in the fan row 30 works abnormally, the indicator unit 47 is lit under the control of the processing unit 431. Thus, the status of the indicator unit 47 can remind and indicate users to observe the terminal device 45 to obtain the positional information of the abnormal fan 32.

In use, each FCB 41 reads a rotational speed of the fan 32 on the fan row 32 through the rotate speed detecting pin TACH, and encodes the read rotational speed to indicate positional information of the fan 32 on the corresponding fan row 30. Then the FCB 41 outputs a PWM signal through the rotational speed control pin PWM to control a rotational speed of the fan 32 according to the read rotational speed from the rotational speed detecting pin TACH. At the same time, the storage unit 422 outputs the encoded rotational speed of each fan 32 to the BMC 43. The BMC 43 receives and processes the encoded rotational speeds of the fans 32, thereby outputting the encoded rotational speeds of the fans 32 which work abnormally. The indicator unit 47 is lit under the control of the BMC 43, thereby reminding and denoting users to observe the terminal device 45 to obtain the positional information of the abnormal fans 32, and maintain or replace the abnormal fans 32.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in the matter of arrangement of parts within the principles of this disclosure to the full extent indicated by the broad general meaning of the terms in which the appended claims are expressed.

What is claimed is:

1. A server system, comprising:
an enclosure;
a plurality of server groups received in the enclosure;
a plurality of fan rows, each fan row serving one server group and comprising a plurality of fans to dissipate heat from the server group; and
a fan indicator system, comprising:
a plurality of fan control boards (FCBs), wherein one FCB is connected to one of the fan rows to read rotational speeds of the fans of the corresponding fan row, each FCB encodes the read rotational speeds to indicate positional information of the corresponding fan row and positional information of each fan on the corresponding fan row;
a baseboard management controller (BMC), wherein the BMC receives and processes the encoded rotational speeds to determine whether the fans work normally; when at least one fan is determined to work abnormally by the BMC, the BMC outputs the encoded rotational speeds of the abnormal fans; and
a terminal device connected to the BMC, wherein the terminal device receives and displays the encoded rotational speeds of the abnormal fans.

2. The server system of claim 1, wherein each FCB comprises a plurality of groups of control pins, one group of control pins corresponds to one fan and comprises a rotational speed detecting pin, the FCB monitors a rotational speed of the fan through the rotational speed detecting pin and encodes the read rotational speed to indicate the positional information of the fan on the corresponding fan row.

3. The server system of claim 2, wherein each group of control pins further comprises a rotational speed control pin, the FCB outputs a pulse width modulation (PWM) signal through the rotational speed control pin to control a rotational speed of the fan according to the read rotational speed.

4. The server system of claim 2, wherein each FCB further comprises a storage unit, the storage unit stores positional information of the plurality of fan rows and positional information of each fan in the fan row, and outputs the encoded rotational speed of each fan to the BMC.

5. The server system of claim 4, wherein the BMC comprises a processing unit, the processing unit is connected to the storage unit to receive and process the encoded rotational speeds from the FCBs, and outputs the encoded rotational speeds of the abnormal fans.

6. The server system of claim 5, wherein the BMC comprises an output port, the BMC is connected to the terminal device through the output port and outputs the encoded rotational speeds of the abnormal fans to the terminal device.

7. The server system of claim 6, wherein the output port is a RJ45 port.

8. The server system of claim 6, wherein the output port is located on a surface of the enclosure.

9. The server system of claim 5, wherein the fan indicator system further comprises an indicator unit, the indicator unit is connected to the processing unit, when at least one fan works abnormally, the indicator unit is lit under the control of the processing unit.

10. The server system of claim 9, wherein the indicator unit is a light-emitting diode.

11. The server system of claim 9, wherein the indicator is located on a surface of the enclosure.
